(19) United States
(12) Patent Application Publication
(10) Pub. No.: US 2015/0292430 A1
(43) Pub. Date: Oct. 15, 2015

(54) Method for Operating a Fuel Injection System with a Fuel Filter Heating Process and Fuel Injection System

(71) Applicant: CONTINENTAL AUTOMOTIVE GMBH, Hannover (DE)

(72) Inventors: Uwe Lingener, Regensburg (DE); Tobias Ritsch, Regensburg (DE)

(73) Assignee: Continental Automotive GmbH, Hannover (DE)

(21) Appl. No.: 14/435,874

(22) PCT Filed: Oct. 10, 2013
(86) PCT No.: PCT/EP2013/071206

§ 371 Date: Apr. 15, 2015

(30) Foreign Application Priority Data
Oct. 15, 2012 (DE) 10 2012 218 749.9
Oct. 7, 2013 (DE) 10 2013 213 506.8

(51) Int. Cl. F02D 41/38; F02M 31/02; F02M 37/00

(52) U.S. Cl. CPC F02D 41/3836; F02M 37/0023; F02M 31/02

(57) ABSTRACT

The invention relates to a method for operating a fuel injection system for an internal combustion engine, having the following steps: filtering fuel using a fuel filter (20), pumping the fuel into a high-pressure volume (52) using a high-pressure pump (24), injecting fuel from the high-pressure volume (52) into a combustion chamber, wherein a first pressure is present in the high-pressure volume (52) at the beginning of the injection process, and heating the fuel filter by recirculating heated fuel. The method is characterized by the additional following steps: increasing the pressure in the high-pressure volume (52) to a second pressure, which is greater than the first pressure, and reducing the pressure in the high-pressure volume (52) from the second pressure to the first pressure, the increase and decrease of the pressure being carried out in the same internal combustion engine work cycle as the injection process.

The invention concerns a method for operating a fuel injection system with a fuel filter heating process and such a fuel injection system. Fuel injection systems for petrol and diesel engines react sensitively to even very small impurities in the fuel. To avoid damage to the fuel injection system from contaminants introduced with the fuel over the entire desired service life, it is necessary to filter out almost completely even minute particle fractions with particle sizes in the range from 3 microns to 5 microns. The fine fuel filters required for this can easily clog under certain conditions.

Particular difficulties arise at very low operating temperatures. For example, with diesel fuels and temperatures below around −25° C., the paraffins flocculate. The resulting paraffin crystals can very quickly block the fuel filter and obstruct the fuel flow so greatly that the engine cuts out. A proportion of water in the fuel can contribute further to the clogging of the fuel filter. For example, diesel fuel can absorb up to around 8% water which can freeze in winter. Comparable problems also occur with other fuel types, for example with a high proportion of biofuel.

The problems outlined may be countered by heating the fuel filter. Electric fuel filter heating systems are known, as are so-called hydraulic fuel filter heating systems. In hydraulic fuel filter heating systems, the power loss from the hydraulic fuel injection is used. By fuel compression and friction heating, the fuel heats up inside the fuel injection system. Hydraulic fuel filter heating systems use the fuel heated in this way to heat the fuel filter. This can be achieved by returning the heated fuel directly to the fuel filter. Also it is possible to return heated fuel to the tank, whereby a higher operating temperature results at the fuel filter.

On this basis, the object of the invention is to propose a method for operating a fuel injection system for an internal combustion engine with which the heating power of a hydraulic fuel filter heating system can be increased, and a corresponding fuel injection system for an internal combustion engine.

The object is achieved by the method with the features of claim 1. Advantageous embodiments are given in the subsequent subclaims.

The method serves for operation of a fuel filter injection system for an internal combustion engine and comprises the following steps:
filtering of fuel using a fuel filter,
delivery of the fuel into a high-pressure volume using a high-pressure pump,
injection of fuel from the high-pressure volume into a combustion chamber, wherein a first pressure predominates in the high-pressure volume at the start of the injection,
heating of the fuel filter by return of the heated fuel,
increasing the pressure in the high-pressure volume to a second pressure which is greater than the first pressure,
reducing the pressure in the high-pressure volume from the second pressure to the first pressure, wherein the rise and fall in pressure take place in the same working cycle of the internal combustion engine as the injection.

The high-pressure volume may in particular be a fuel accumulator, often known as a common rail in diesel internal combustion engines. It may however also be an accumulator-free injection system, in which the high-pressure volume from which the fuel is taken for injection is for example formed by a high-pressure fuel line.

Injection of the fuel from the high-pressure volume into a combustion chamber may take place in particular with at least one injector connected to the high-pressure volume. The first pressure corresponds to a predefined nominal value in the high-pressure volume which desirably should be maintained at the time of starting the injection. The first pressure depends on the operating state of the internal combustion engine. For example when the internal combustion engine is idling, with a common rail diesel engine, the pressures may lie in the range from 150 bar to 300 bar, while under full load pressures of 2000 bar or more may be reached.

The fuel filter is heated by the return of the heated fuel, wherein the fuel is heated using a “hydraulic power loss” of the fuel injection system. The compression of the fuel in particular contributes to this hydraulic power loss. For example, diesel fuel is heated by compression by around 14 K per 1000 bar. An even greater contribution to heating comes from friction, in particular at a pressure reduction valve such as a choke, whereby heating of around 55 K per 1000 bar results.

The heat input ΔQ into the fuel, which may be used for heating the fuel filter, arises from the correlation

ΔQ=ΔT*ρ*cᵥ*\dot{V}·Accordingly, the heat input ΔQ is equal to the temperature rise ΔT multiplied by the density ρ of the fuel, the specific thermal capacity cᵥ of the fuel, and the volume flow \dot{V} of the fuel. The heat input ΔQ therefore depends on the temperature difference created by the hydraulic power loss, which in turn is determined by the pressure differences on compression and pressure reduction. This correlation has been found by the inventors, who have established that difficulties as a result of insufficient heating power occur in particular at idle when the first pressure in the high-pressure volume has relatively low values. This leads to relatively low temperature differences and consequently low heat input.

The invention is furthermore based on the finding that merely increasing the first pressure, in particular in idle mode, is undesirable because such an increase and the correspondingly higher injection pressure lead to a higher noise level at idle, which is undesirable. In the invention therefore the first pressure remains unchanged for the injection. At the same time, it is possible to increase the heating power substantially in that, within the same working cycle in which injection takes place at the first pressure, the pressure in the high-pressure volume is increased to a second pressure which is greater than the first pressure, and (then) lowered from the second pressure to the first pressure. This additional compression and pressure reduction leads to an increase in the hydraulic power loss and hence in the heating power available from the fuel injection system.

In one embodiment, the rise and fall in pressure take place only if the temperature in the region of the fuel filter lies below a predefined minimum temperature. The temperature in the region of the fuel filter may be detected with a temperature sensor. The temperature sensor may be arranged so that it detects a temperature of the fuel filter and/or a temperature of the fuel present in the fuel filter and/or a temperature of the fuel upstream of the fuel filter. In this embodiment, the higher hydraulic power loss of the system is generated only if a stronger heating of the fuel filter is required.

In one embodiment, the rise and fall in pressure take place only if the first pressure lies below a predefined minimum value. The predefined minimum value may be selected for example in the range from 500 bar to 1000 bar. The first pressure is a nominal value which is in any case available in a control system for controlling the fuel injection system. This embodiment leads to a particularly simple activation of the increased heating power adapted to demand. It assumes that at the first pressure above the predefined minimum value, sufficient heating power is available even without the additional rise and fall in pressure according to the invention.

In one embodiment, the pressure difference between the first pressure and the second pressure is dependent on a temperature in the region of the fuel filter. The temperature in the region of the fuel filter may be detected, as explained above in connection with the predefined minimum temperature. The additionally available heating power is dependent on this pressure difference. It is therefore useful to select this in particular higher at low temperatures in the region of the fuel filter than at high temperatures. This measure ensures the additionally available heating power is controlled particularly according to demand.

In one embodiment, the pressure difference between the first pressure and the second pressure is 50 bar or more. The pressure difference may in particular lie in a range of around 100 bar to 200 bar. Pressure differences of this order of magnitude lead to a sufficient increase in the heating power and are relatively simple to implement.

In one embodiment, the pressure rise is achieved by increasing a delivery quantity of the high-pressure pump. In this way the pressure in the high-pressure volume can easily be increased in a targeted fashion.

In one embodiment, the delivery quantity is controlled by controlling the opening period of a digital inlet valve of the high-pressure pump. A digital inlet valve, in contrast to a proportional valve, is switched to and fro in operation between a fully opened and a fully closed position. The opening period corresponds to a period in which the digital inlet valve is in the open position. Within this period, in particular a working volume of the high-pressure pump may be filled with fuel. Since a digital inlet valve can be controlled very quickly and precisely, a particularly dynamic and precise predetermination of the delivery quantity is possible.

In one embodiment, the delivery quantity is set to a maximum possible value which can be achieved within the working cycle using the high-pressure pump. On use of a digital inlet valve, consequently the opening period may constitute the entire working stroke in which the working volume of the high-pressure pump can be filled. This maximizes the additional power loss.

In one embodiment, the pressure fall is achieved by opening a pressure reduction valve connected to the high-pressure volume.

The fuel escaping from the high-pressure volume via the pressure reduction valve can be returned for heating the fuel filter. In conjunction with an increased delivery quantity of the high-pressure pump for the pressure rise, the fall in the pressure by such drainage of fuel from the high-pressure volume via the pressure reduction valve, in addition to the higher temperature difference explained above, leads to an increased volume flow of the returned heated fuel. Therefore there is a particularly strong increase in the possible heat input. In one embodiment, the pressure reduction valve is a digital pressure reduction valve which is switched to and fro between an opened and a closed position. As explained above in connection with the digital inlet valve, this allows a particularly precise and dynamic control of the pressure fall in the high-pressure volume.

In one embodiment, the internal combustion engine is at idle and the first pressure lies in the range of 100 bar to 400 bar. As already explained, the method according to the invention can be used particularly profitably at idle and at relatively low pressures at the time of injection.

### Supplement:

The temporal development of the rise and fall in pressure can be selected in particular such that the steps of pressure rise, pressure fall and fuel injection take place in this order, and more or less immediately in succession. Also, there may be precisely one pressure rise and one pressure fall for each cylinder segment of the internal combustion engine, i.e. for each cylinder and an associated injection window. The pressure rise and fall can therefore take place repeatedly within a working cycle of the internal combustion engine, in particular corresponding to the number of (main) injection processes.

In one embodiment, the high-pressure pump is a piston pump which reaches a top dead center 80° to 20° of a crankshaft revolution of the internal combustion engine earlier than a piston of the internal combustion engine. The time sequence resulting from this relative arrangement of the top dead centers of a piston of the internal combustion engine and a piston of the high-pressure pump means that, after reaching the top dead center of the high-pressure pump i.e. at the end of the pressure rise in the high-pressure volume, sufficient time remains available for the pressure fall before the main injection into the corresponding combustion chamber of the internal combustion engine, which takes place approximately at

top dead center of the upper piston. The time available for the additional pressure rise and fall is utilized to the optimum.

The object outlined above is also achieved by a fuel injection system with the features of claim 13. The fuel injection system is intended for an internal combustion engine and has the following features:
a fuel filter,
a high-pressure pump,
a high-pressure volume which is connected to a high-pressure output of the high-pressure pump,
at least one injector for injecting fuel from the high-pressure volume into a combustion chamber,
a pressure reduction valve connected to the high-pressure volume,
a fuel return device which is configured to return heated fuel in order to heat the fuel filter,
a control system which is configured to control the pressure in the high-pressure volume by controlling the high-pressure pump and/or pressure reduction valve such that a first pressure predominates in the high-pressure volume before injection, wherein
the control system is configured to increase the pressure in the high-pressure volume to a second pressure which is greater than the first pressure, and to reduce this pressure from the second pressure to the first pressure, wherein the rise and fall in pressure take place in the same working cycle of the internal combustion engine as the injection.

The fuel injection system is intended in particular for performance of the method according to the invention. To explain the features of the fuel injection system and its particular advantages, reference is made to the above explanations of the method which apply accordingly.

Evidently each of the features of the fuel injection system may be used in conjunction with the method according to the invention, even if this was not explicitly explained in the explanation of the method. For example, the return of fuel in the method according to the invention may take place with a fuel return device, and so on.

The internal combustion engine can work on the diesel or petrol principle.

In one embodiment, the high-pressure pump is a piston pump which is driven by a cam coupled to a crankshaft of the internal combustion engine, wherein the installation phase position between a top dead center of the piston pump and a top dead center of a piston of the internal combustion engine lies in the range from −80° to −20° of a crankshaft revolution. In particular, a high-pressure pump with a single piston may be used. In connection with two cams per crankshaft revolution for driving the piston pump, this pump has two delivery cycles per crankshaft revolution. In connection with a four-cylinder, four-stroke engine, this configuration means that the pressure rise and fall takes place once in each cylinder segment. For further explanation, reference is made to the above statements referring to the corresponding method claim.

In one embodiment, the fuel injection system is configured to carry out one or more of the method steps as claimed in any of claims 2 to 11. Where these method steps describe a specific process, this means that the control system of the fuel injection system is configured such that the corresponding steps are carried out.

The invention is explained in more detail below with reference to an exemplary embodiment shown in two figures. These show:

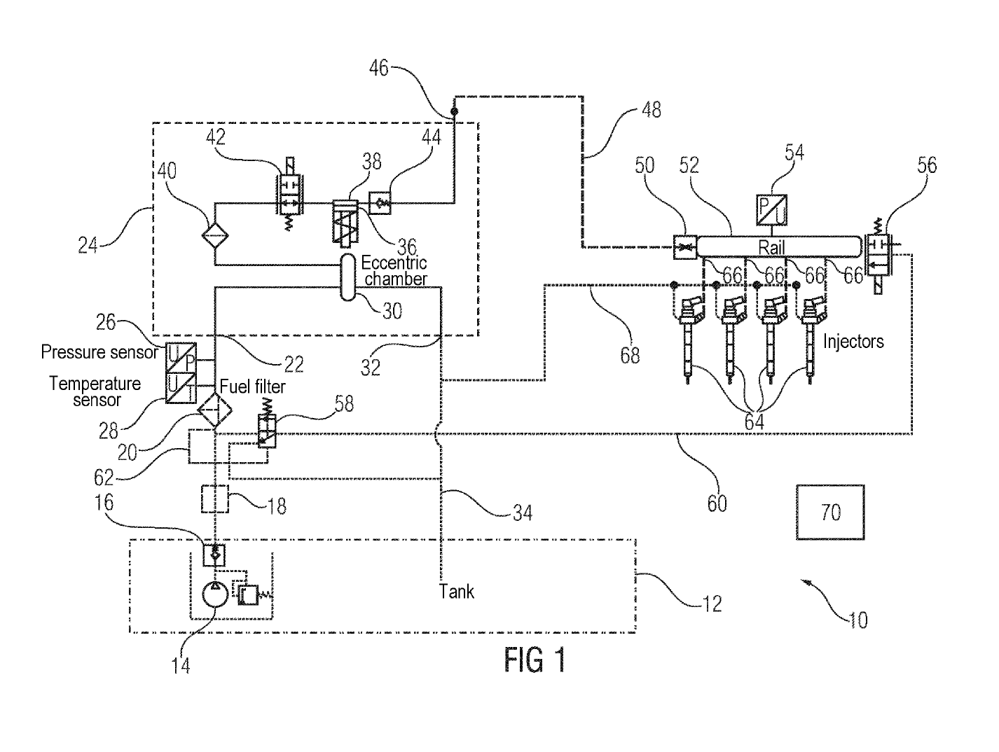

FIG. 1 a fuel injection system according to the invention in a diagrammatic simplified depiction,

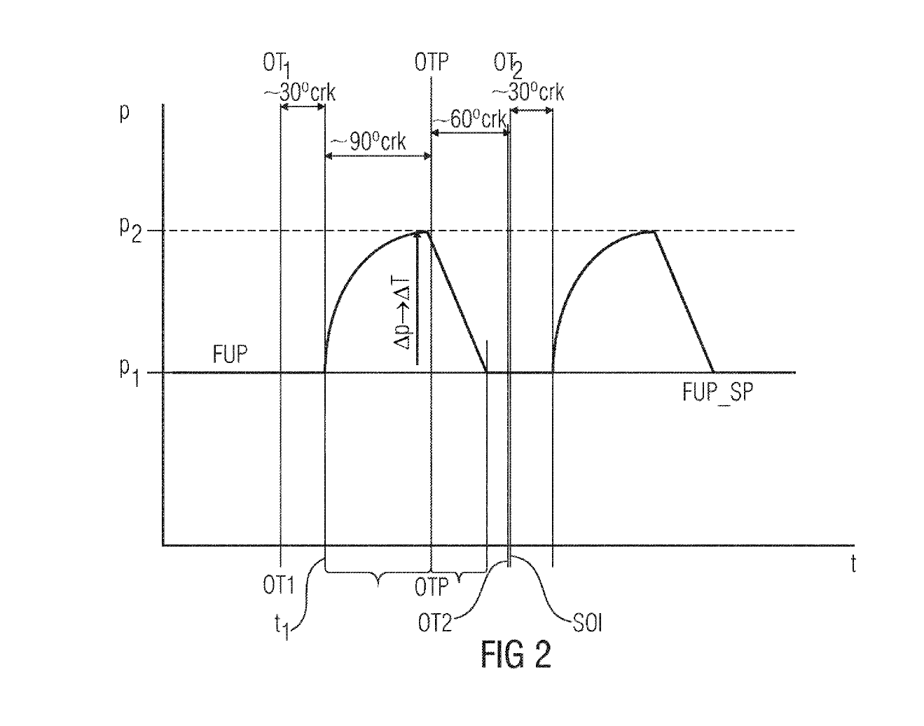

FIG. 2 a diagram of the temporal development of the pressure in the high-pressure volume on performance of the method according to the invention.

The fuel injection system 10 from FIG. 1 has a fuel tank 12 in which an electric pre-delivery pump 14 is arranged. From an output of the electric pre-delivery pump 14, the fuel passes via a non-return valve 16 and a water trap 18 to a fuel filter 20, and from there to a fuel feed 22 of a high-pressure pump 24.

A low pressure sensor 26 and a temperature sensor 28 are arranged between the fuel filter 20 and the fuel feed 22 of the high-pressure pump 24. These two sensors measure the pressure and temperature in the region of the fuel filter 20. The high-pressure pump 24 has a so-called eccentric chamber 30 which is connected to the fuel inlet 22. A fuel return 32 of the high-pressure pump 24 is also connected to the eccentric chamber 30. The fuel return 32 is connected to the tank 12 via a fuel return line 34, so that a proportion of the fuel flow delivered by the electric pre-delivery pump 14, which serves substantially for cooling and lubrication of the high-pressure pump 24, can be returned to the fuel tank 12.

A cam (not shown) is present in the eccentric chamber 30, which is coupled to a crankshaft of the internal combustion engine and drives a piston 36 of the high-pressure pump. A working volume 38 of the high-pressure pump 24 can be pressurized by the piston 36. For this, the fuel feed 22 is connected to the working volume 38 via the eccentric chamber 28, a further fuel filter 40 and a digital inlet valve 42.

To fill the working volume 38 with fuel, the digital inlet valve (DIV) is opened during a downward movement of the piston 36. On a subsequent upward movement of the piston 36,

a pressure of for example up to 2000 bar or more is generated in the working volume 38. The working volume 38 is connected to a high-pressure output 46 of the high-pressure pump 24 via a further non-return valve 44.

The high-pressure output 46 of the high-pressure pump 24 is connected via a high-pressure line 48, in which a choke 50 is arranged, to a high-pressure volume 52, in this example a common rail. A high-pressure sensor 54 is also connected to the high-pressure volume 52 and allows pressure monitoring in the high-pressure volume 52 and corresponding pressure regulation. Furthermore, a pressure reduction valve 56 is connected to the high-pressure volume 52.

A fuel return device for heating the fuel filter 20 has a thermostatic valve 58 and a fuel line 60 which is connected to an outlet of the pressure reduction valve 56. The thermostatic valve 58 is connected on the outlet side to a fuel line leading from the electric pre-delivery pump 14 to the fuel filter 20, specifically upstream of the fuel filter 20 and directly adjacent to the fuel filter 20. The temperature-dependent control of the thermostatic valve 58 takes place by detecting the temperature at the inlet to the fuel filter 20 using the line 62.

Four injectors 64 are connected via high-pressure lines 66 with the high-pressure volume 52 and inject fuel out of the high-pressure volume 52 into combustion chambers (not shown). The injectors 64 are also connected to the fuel return line 34 via a common injector return line 68, so that leakage flow from the injectors 64 can be returned to the fuel tank 12.

An electronic control system 70 is indicated in FIG. 1 by a box. It is connected to the electric pre-delivery pump 14, the digital inlet valve 42 of the high-pressure pump 24, the pressure reduction valve 56, the injectors 64, the low pressure sensor 26, the temperature sensor 28 and the high-pressure sensor 54. The control system 70 is in particular configured to control the digital inlet valve 42 and hence to control the fuel quantity delivered by the high-pressure pump 24 or delivered into the high-pressure volume 52. By increasing this delivery quantity, the pressure in the high-pressure volume 52 can be increased. The control system 70 is also configured to lower the pressure in the high-pressure volume 52 by controlling the pressure reduction valve 56. By controlling the injectors 64 and the fuel quantity injected into the combustion chambers, the control system 70 also has an influence on the fuel outflow from the high-pressure volume 52 via the injectors and the injector return line 68. In particular by targeted control of the digital inlet valve 42 and the pressure reduction valve 56, the control system 70 controls the first pressure predominating at the time of each injection into the high-pressure volume 52. This may correspond to different predefined nominal values irrespective of the operating state of the internal combustion engine.

In addition to this regulation of the pressure in the high-pressure volume 52 to a first pressure in each working cycle of the internal combustion engine or in each cylinder segment, in the invention the pressure in the high-pressure volume 52 may also be increased to a second pressure which is greater than the first pressure, and then lowered to the first pressure again. The resulting greater pressure differences of the fuel lead to a stronger heating of the fuel flowing out at the outlet from the pressure reduction valve 56. Also, the volume flow available there is increased, so that the heat quantity which is available for heating the fuel filter 20 and which can be supplied to the fuel filter 20 via the fuel line 60 and the thermostatic valve 58, is greatly increased.

The temporal development of the method according to the invention will be explained in more detail with reference to FIG. 2. The pressure p in the high-pressure volume 52 is shown over time t.

At the far left of the diagram, a first pressure p₁ predominates in the high-pressure volume 52. This corresponds to the nominal value of the pressure which should predominate in the high-pressure volume 52 at the start of each injection process. When the internal combustion engine is at idle, this first pressure p₁ may for example lie in the range from 150 to 300 bar.

At time OT1, a first piston of the internal combustion engine is at top dead center and a fuel injection takes place into the cylinder belonging to this piston, usually shortly after reaching the first top dead center. The first pressure p₁ continues to predominate in the high-pressure volume 52 within the associated injection window in which this injection can take place.

At the time designated t₁, the high-pressure pump 24 begins to deliver fuel into the high-pressure volume 52. This results in an initially faster, then slower, pressure rise in the high-pressure volume 52 up to a second pressure p₂. This pressure rise in the high-pressure volume 52 up to the second pressure p₂ is completed at the time designated OTP. The period between t₁ and OTP corresponds to around 90° of a crankshaft revolution.

In the example, during this 90° movement of the crankshaft, a maximum possible delivery quantity from the high-pressure pump 24 is called off, which results directly in an increase in the pressure up to the second pressure p₂.

At the time designated OTP, the pressure reduction valve 56 is opened so that during the following period, a substantially linear pressure fall occurs down to the first pressure p₁. The pressure reduction valve 56 is here controlled such that the pressure is reduced to value p₁ in good time before a further piston of the internal combustion engine reaches the top dead center OT2. In this example, around 60° of a crankshaft revolution are available for the pressure fall. When the further piston reaches the top dead center OT2, the first pressure p₁ has stabilized again and a fuel injection can take place into the associated combustion chamber. The time decisive for this is indicated in FIG. 2 as SOI for Start Of Injection. Then the pressure in the high-pressure volume 52 is increased again, and reduced again to value p₁ in good time before the next injection. All steps shown in the diagram take place within the same working cycle of the internal combustion engine, which in this example is only completed after two full crankshaft revolutions, i.e. 720°. As evident from FIG. 2, the installation phase position of the high-pressure pump 24 relative to a piston of the internal combustion engine is selected such that the top dead center (OTP) of the piston of the high-pressure pump 24 is reached around 60° of a crankshaft revolution before the top dead center (OT2) of a piston of the internal combustion engine.

What is claimed is:

1. A method for operating a fuel injection system for an internal combustion engine, the method comprising:
filtering fuel using a fuel filter,
delivering the fuel into a high-pressure volume using a high-pressure pump,
injecting the fuel from the high-pressure volume into a combustion chamber, wherein a first pressure predominates in the high-pressure volume at the start of the injection, heating the fuel filter by a return of the heated fuel,
increasing the pressure in the high-pressure volume to a second pressure greater than the first pressure, and
reducing the pressure in the high-pressure volume from the second pressure to the first pressure, wherein the increase and decrease in pressure occur in the same working cycle of the internal combustion engine as the injection of the fuel.

2. The method of claim 1, wherein the increase and decrease in pressure occur only if the temperature in the region of the fuel filter lies below a predefined minimum temperature.

3. The method of claim 1, wherein the increase and decrease in pressure occur only if the first pressure lies below a predefined minimum value.

4. The method of claim 1, wherein the pressure difference between the first pressure and the second pressure is dependent on a temperature in the region of the fuel filter.

5. The method of claim 1, wherein the pressure difference between the first pressure and the second pressure is 50 bar or more.

6. The method of claim 1, wherein the pressure increase is achieved by increasing a delivery quantity of the high-pressure pump.

7. The method of claim 6, wherein the delivery quantity is controlled by controlling the opening period of a digital inlet valve of the high-pressure pump.

8. The method of claim 6, wherein the delivery quantity is set to a maximum possible value which can be achieved within the working cycle using the high-pressure pump.

9. The method of claim 1, wherein the pressure decrease is achieved by opening a pressure reduction valve connected to the high-pressure volume.

10. The method of claim 9, wherein the pressure reduction valve is a digital pressure reduction valve which is switched to and fro between an opened and a closed position.

11. The method of claim 1, wherein the internal combustion engine is at idle and the first pressure lies in the range of 100 bar to 400 bar.

12. The method of claim 1, wherein the high-pressure pump is a piston pump which reaches a top dead center 80° to 20° of a crankshaft revolution of the internal combustion earlier than a piston of the internal combustion engine.

13. A fuel injection system for an internal combustion engine, the fuel injection system comprising:
a fuel filter,
a high-pressure pump,
a high-pressure volume connected to a high-pressure output of the high-pressure pump,
at least one injector for injecting fuel from the high-pressure volume into a combustion chamber,
a pressure reduction valve connected to the high-pressure volume,
a fuel return device configured to return heated fuel in order to heat the fuel filter, and
a control system which is configured to:
control the pressure in the high-pressure volume by controlling at least one of the high-pressure pump or the pressure reduction valve such that a first pressure predominates in the high-pressure volume before an injection,
increase the pressure in the high-pressure volume to a second pressure greater than the first pressure, and
reduce this pressure from the second pressure to the first pressure, wherein the increase and decrease in pressure occur in the same working cycle of the internal combustion engine as the injection.

14. The fuel injection system of claim 13, wherein the high-pressure pump is a piston pump driven by a cam coupled to a crankshaft of the internal combustion engine, wherein the installation phase position between a top dead center of the piston pump and a top dead center of a piston of the internal combustion engine lies in the range from −80° to −20° of a crankshaft revolution.

15. The fuel injection system of claim 13, wherein the increase and decrease in pressure occur only if the temperature in the region of the fuel filter lies below a predefined minimum temperature.

16. The fuel injection system of claim 13, wherein the increase and decrease in pressure occur only if the first pressure lies below a predefined minimum value.

17. The fuel injection system of claim 13, wherein the pressure difference between the first pressure and the second pressure is dependent on a temperature in the region of the fuel filter.

18. The fuel injection system of claim 13, wherein the pressure difference between the first pressure and the second pressure is 50 bar or more.

19. The fuel injection system of claim 13, wherein the pressure increase is achieved by increasing a delivery quantity of the high-pressure pump.

20. The fuel injection system of claim 13, wherein the pressure decrease is achieved by opening a pressure reduction valve connected to the high-pressure volume.
